(19) United States
(12) Patent Application Publication
(10) Pub. No.: US 2007/0205579 A1
(43) Pub. Date: Sep. 6, 2007

(54) Steering mechanism assembly for trailers

(76) Inventor: Jean-Paul Plante, Quebec (CA)

Correspondence Address: Mr. Jean-Paul Plante, 22 des Chenes, St-Etienne, QC, G6J 1L6, CA

(21) Appl. No.: 11/356,284

(22) Filed: Feb. 17, 2006

(51) Int. Cl. B62D 13/00

(52) U.S. Cl. 280/442

(57) ABSTRACT

A steering mechanism assembly for trailer, which the steering mechanism assembly comprises two wheels free to pivot that are assembled to the trailer, and a means for pivoting an axle to shift the camber angle for turning direction of the wheels of the trailer to follow the steering wheels of the towing vehicle when the towing vehicle moves in both a forward and a reverse direction, and to keep the wheels in parallel.

### BACKGROUND OF THE INVENTION

1. Field of the Invention

This invention is directed toward a steering mechanism assembly for a trailer, which the trailer wheels follow the steering wheels of the towing vehicle when the towing vehicle moves in both a forward and a reverse direction.

2. Dsecription of the Related Art

A search of prior art records has unveiled the following patents:
1. U.S. Pat. No. 4,405,147 issued in 1983 to Horsman et al.
2. U.S. Pat. No. 4,345,775 issued in 1982 to Merrifield.
3. U.S. Pat. No. 4,171,825 issued in 1979 to Woodell.
4. U.S. Pat. No. 3,753,580 issued in 1973 to Folkert.

### SUMMARY OF THE INVENTION

In accordance with the teachings of the present invention, there is disclosed a steering mechanism assembly for trailer, which the steering mechanism assembly comprising:

two wheels free to pivot that are assembled to the trailer;

means for interconnecting the trailer to a towing vehicle, which comprising:

a pair of hitch for attachment with each ball coupled to tow bar of the towing vehicle;

means for pivoting an axle to shift the camber angle for turning direction of the trailer wheels to follow the steering wheels of the towing vehicle when the towing vehicle moves in both a forward and a reverse direction, which comprising:

an electric cable connected to the backup lights of the towing vehicle, of which the electric cable operates a motor for actuating a lever forward/backward in the longitudinal direction of the trailer, of which the lever is connected to one end of the axle pivotally connected to the structure of the trailer and to cambers for turning direction of the wheels, and wherein the cambers are secured to a connector rod for keeping the wheels in parallel;

means for securing the axle to leaf spring coupled to the structure of the trailer, which comprising:

two supporting plates; and

means for keeping the trailer at level when it is not attached to the towing vehicle, which comprising:

a wheel support approximately coupled in a middle of the front structure of the trailer.

The movement of the trailer wheels is constrained by a shock absorber approximately coupled in a middle of the axle and to one end of the connector rod for preventing the vibrational motion of the wheels from all sides when the trailer rolls at high speed.

### BRIEF DESCRIPTION OF THE DRAWINGS

FIG. 1 is a top view of a trailer incorporating the steering mechanism assembly of the invention;

FIG. 2 is a bottom view thereof;

FIG. 3 is a bottom elevation view thereof.

FIGS. 4 and 5 show a bottom view of the trailer incorporating the steering mechanism of the invention in operation.

FIG. 6 shows a rear elevation view of the trailer incorporating the steering mechanism assembly of the invention.

FIGS. 7a and 7b show the prior art trailer in operation.

FIG. 8 is an exploded view of the trailer incorporating the steering mechanism of the invention in position for assembly.

FIG. 9 is an exploded view of the steering mechanism of the invention in position for assembly.

FIG. 10a is a side view showing the steering mechanism when the trailer moves in a forward direction.

FIG. 10b is a side view showing the steering mechanism when the trailer moves in a reverse direction.

FIGS. 11a and 11b show a detailed view of the steering mechanism of the invention in operation.

### DETAILED DESCRIPTION OF THE INVENTION

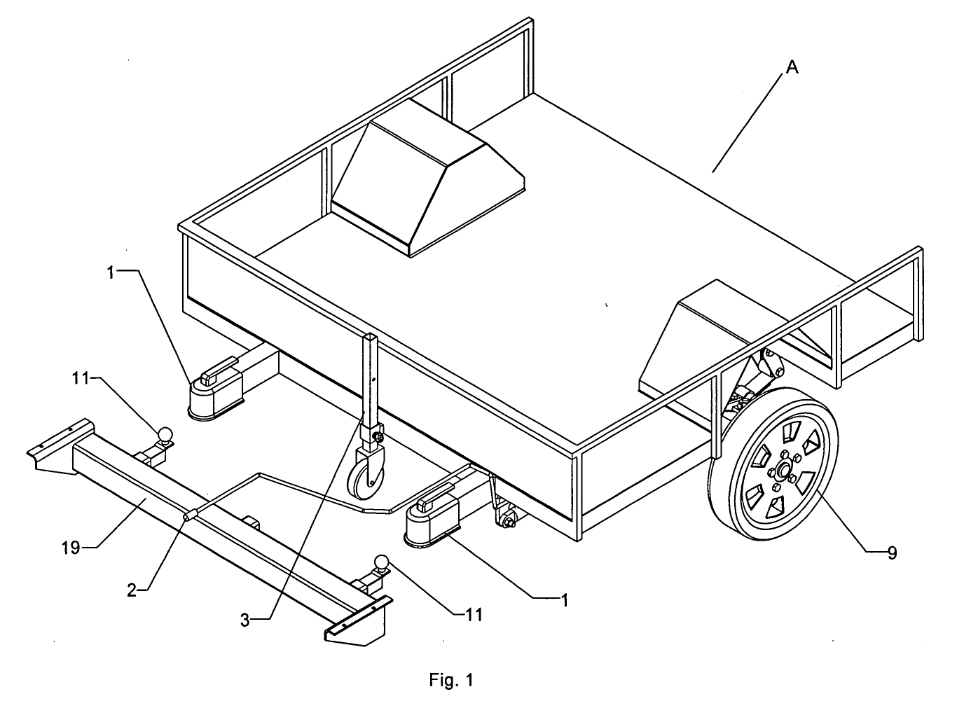

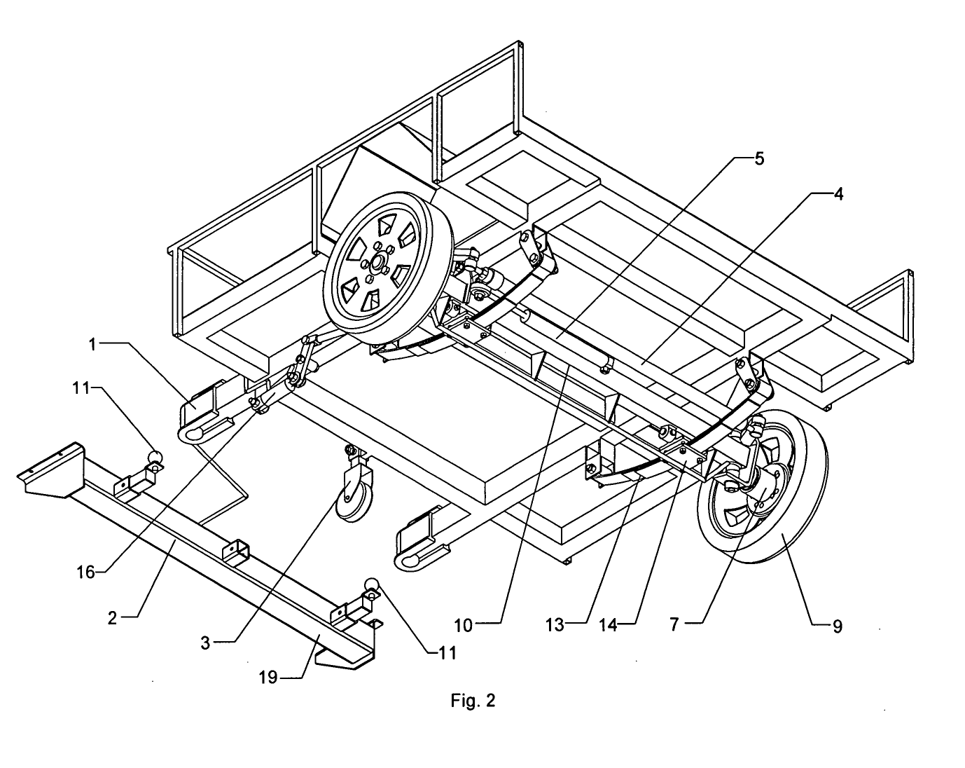

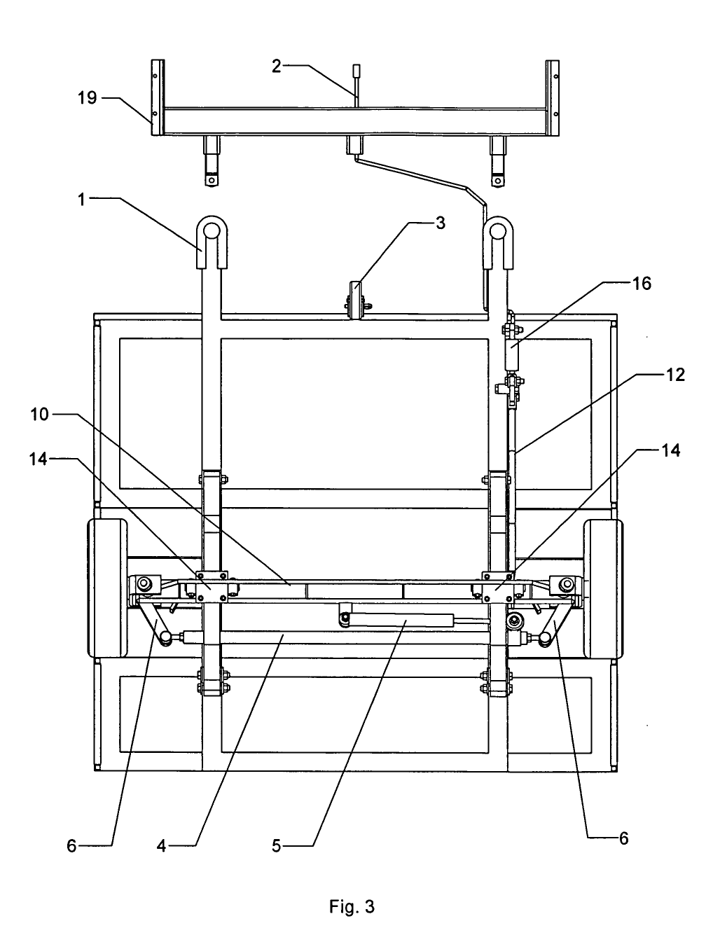

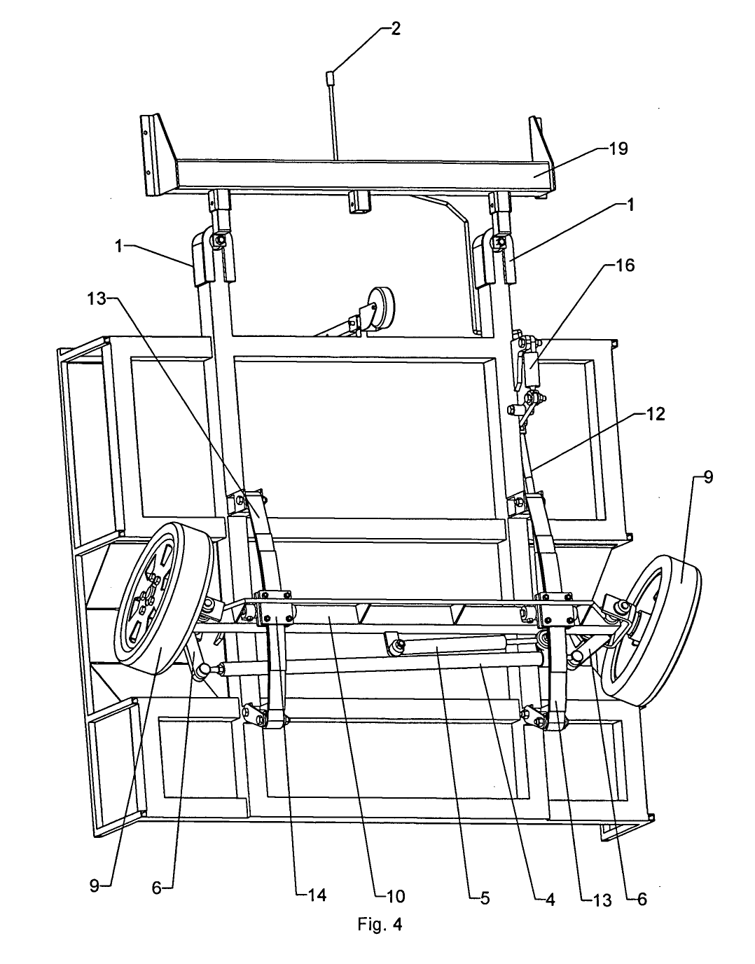

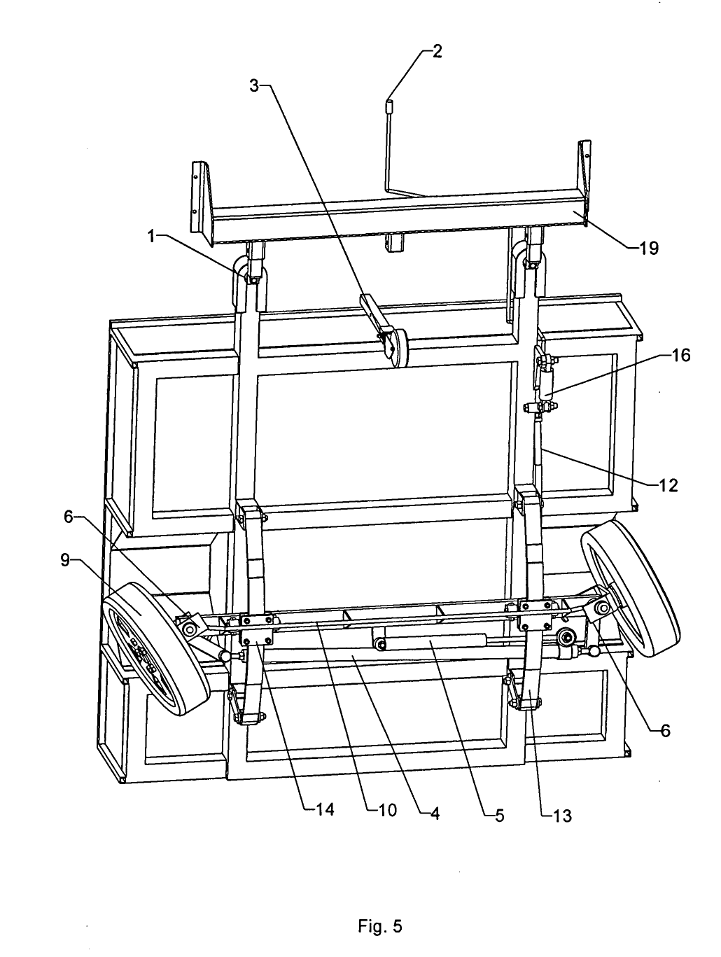

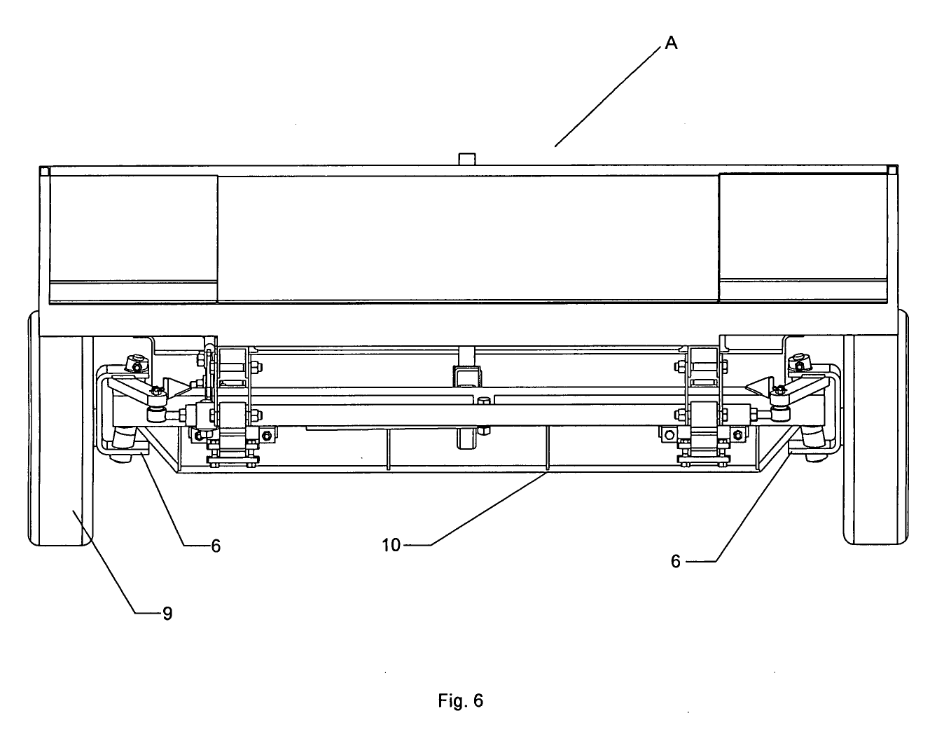

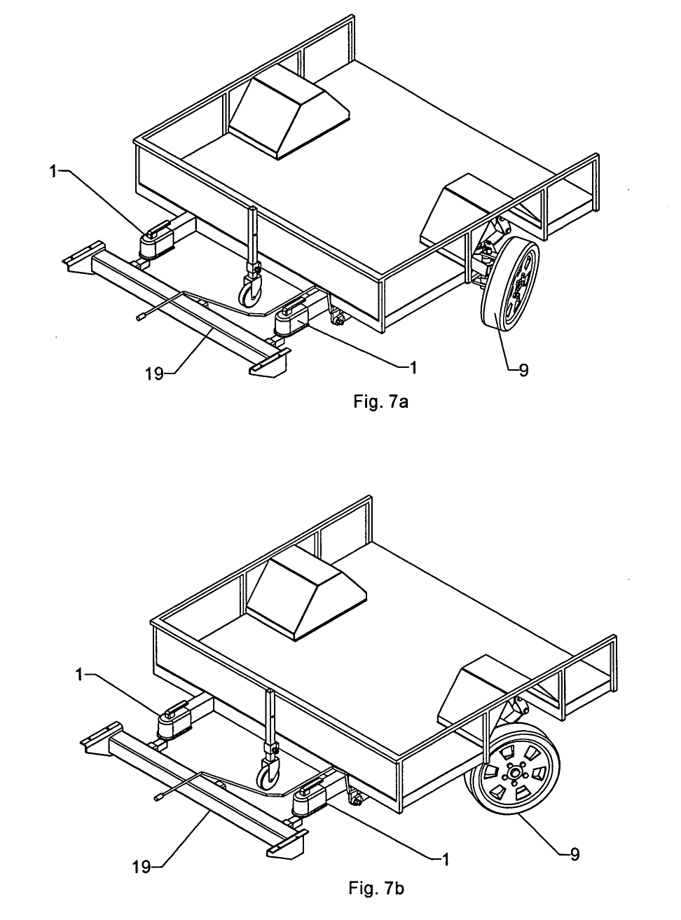

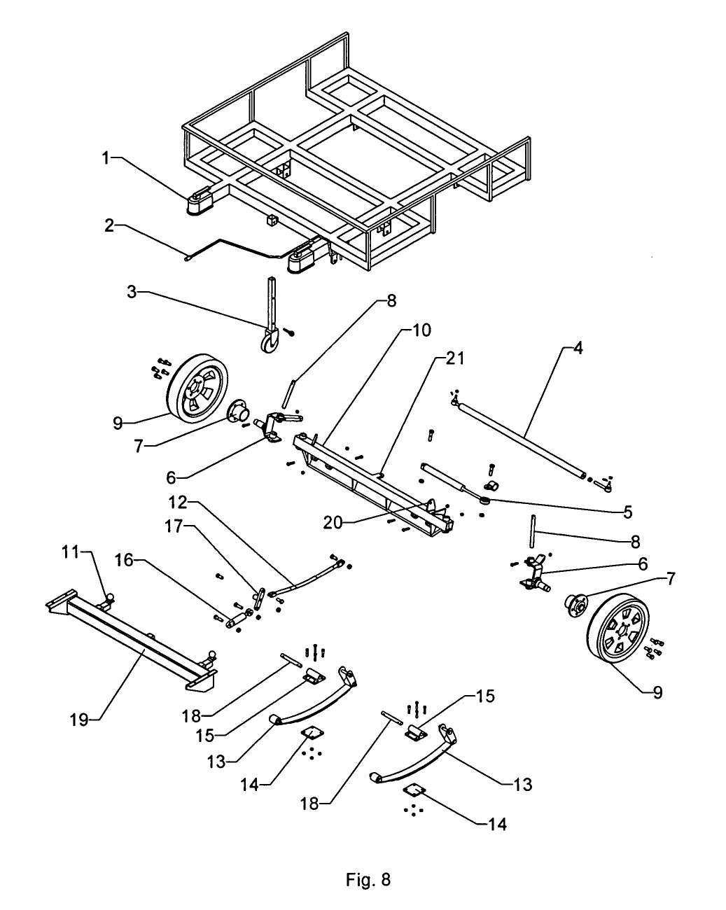

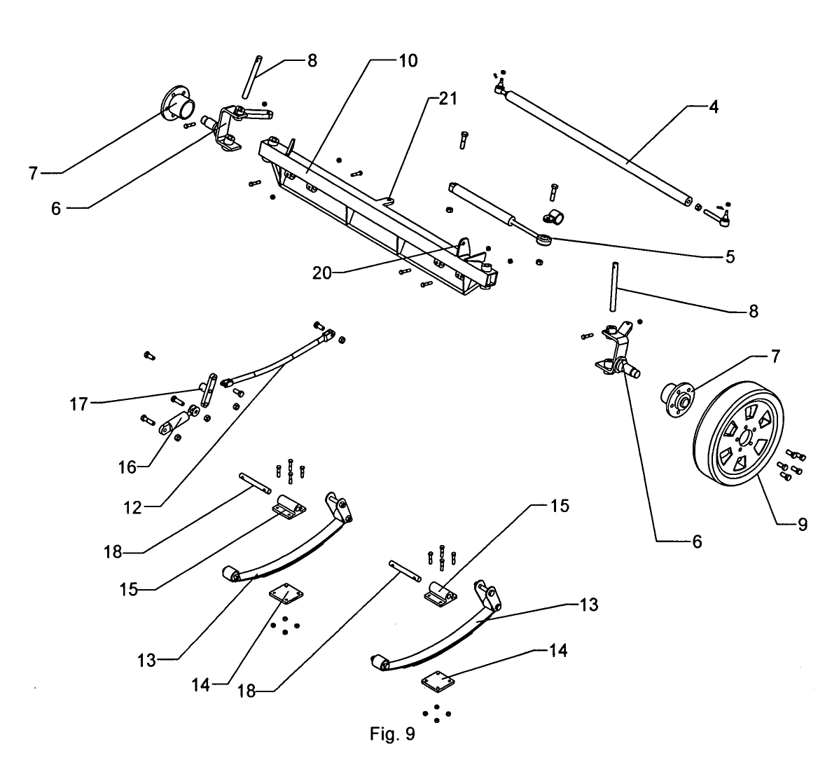

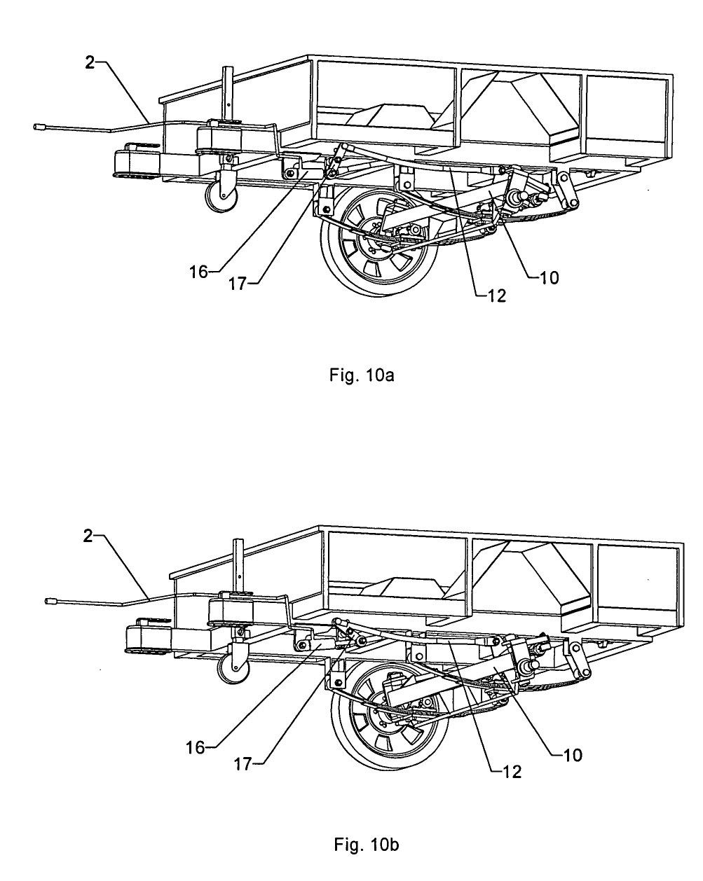

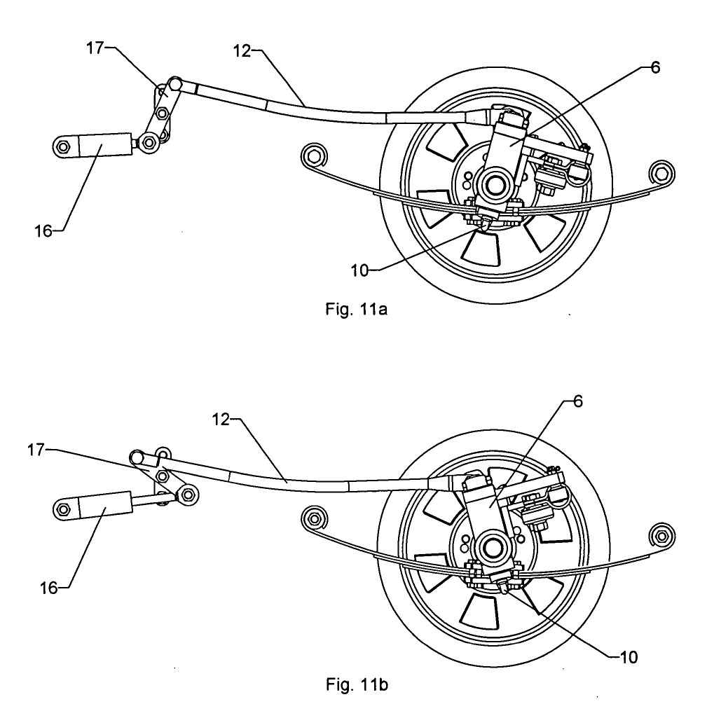

With reference to FIGS. 1 to 11, there is illustrated a trailer (A) having a pair of hitch (1) for attachment with each ball (11) coupled to a tow bar (19) of a towing vehicle.

In accordance with the teachings of the present invention, there is disclosed a steering mechanism assembly for trailer, which the steering mechanism assembly is comprised of two wheels (9) free to pivot that are assembled to the trailer (A); an electric cable (2) which interconnects the trailer to the backup lights of the towing vehicle, of which the electric cable (2) operates a motor (16) for actuating a lever (17) forward/backward in the longitudinal direction of the trailer, of which the lever (17) is connected to one end of an axle (10) pivotally connected to the structure of the trailer and to cambers (6) for turning direction of the wheels (9) to follow the steering wheels of the towing vehicle when the towing vehicle moves in both a forward and a reverse direction, and wherein the cambers (6) are secured to a connector rod (4) for keeping the wheels (9) in parallel.

Further, the axle (10) is secured to leaf spring (13) coupled to the structure of the trailer by means of two supporting plates (14).

Since again, the movement of the wheels (9) is constrained by a shock absorber (5) approximately coupled in a middle of the axle (10) and to one end of the connector rod (4) for preventing the vibrational motion of the wheels (9) from all sides when the trailer rolls at high speed.

And finally, a wheel support (3) is approximately coupled in a middle of the front structure of the trailer for keeping the trailer (A) at level when it is not attached to the towing vehicle.

Although only a single embodiment of the present invention has been described and illustrated, the present invention is not limited to the features of this embodiment, but includes all variations and modifications within the scope of claims.

The embodiments of the invention for which an exclusive property or privilege is claimed, are defined as follows:

1. A steering mechanism assembly for trailer, which the steering mechanism assembly comprising:
two wheels free to pivot that are assembled to the trailer;
means for interconnecting the trailer to a towing vehicle, which comprising:
a pair of hitch for attachment with each ball coupled to tow bar of the towing vehicle;
means for pivoting an axle to shift the camber angle for turning direction of the trailer wheels to follow the steering wheels of the towing vehicle when the towing vehicle moves in both a forward and a reverse direction, which comprising:
an electric cable connected to the backup lights of the towing vehicle, of which the electric cable operates a motor for actuating a lever forward/backward in the longitudinal direction of the trailer, of which said lever is connected to one end of the axle pivotally connected to the structure of the trailer and to cambers for turning direction of the wheels, and
wherein said cambers are secured to a connector rod for keeping the wheels in parallel;
means for securing said axle to leaf spring coupled to the structure of the trailer, which comprising:
two supporting plates; and
means for keeping the trailer at level when it is not attached to the towing vehicle, which comprising:
a wheel support approximately coupled in a middle of the front structure of the trailer.
